(19) United States
(12) Patent Application Publication
(10) Pub. No.: US 2006/0215522 A1
(43) Pub. Date: Sep. 28, 2006

(54) Disc identification system

(75) Inventor: Max Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/088,649

(22) Filed: Mar. 24, 2005

(51) Int. Cl. G11B 7/00

(52) U.S. Cl. 369/53.37; 369/53.2

(57) ABSTRACT

An identification system for a DVD player is capable of determining whether a DVD has been inserted therein. The method reads additional information and evaluates characteristics of the digital versatile disc (DVD) or compact disc (CD). A database storing DVD identification information for use in a DVD player, comprising a characteristic column for storing a characteristic value as a primary index and a data column for storing a disc profile comprising customized information of a DVD.

### BACKGROUND

The invention relates to a method of disc identification, and in particular, to an identification system for a DVD player capable of reading additional information and evaluating characteristics of digital versatile discs (DVDs) or compact discs (CDs).

Current DVD players are capable of identifying a DVD by reading a label, a table of contents and the serial number therein. DVDs typically comprise information label, table of contents and serial numbers; however, some DVDs do not. In this case, only through playing the DVD can the content therein be identified. In addition to format compatibility issues, DVD identification may fail due to data loss caused by disc damage. Conventionally, ejection of a DVD results in loss of playback parameters, including the point where disc play has stopped, customized language and view angle selections. Thus, when the same DVD is inserted again, the settings must be reconfigured, which may be considered inconvenient. Thus an enhanced disc identification system is desirable.

### SUMMARY

An embodiment of the invention provides an identification method for a DVD player. The identification method comprises the following steps. First, file information from a digital versatile disc (DVD) is read, and a characteristic value is generated from the file information. Thereafter, whether the characteristic value exists in a database, is verified, and a corresponding disc profile indicating further functionality is obtained if the characteristic value exists in the database. If no additional characteristic value exists in the database, the characteristic value, and the corresponding disc profile are added to the database. When ejecting the DVD, the corresponding disc profile in the database is updated.

Another embodiment of the invention provides a database storing DVD identification information for use in a DVD device. The database comprises a characteristic column for storing a characteristic value as a primary index, and a data column for storing a disc profile comprising customized information of a DVD. The disc profile comprises a stop point for indicating addresses where last play stopped, a text column for adding descriptions of files on the DVD, an address book for keeping favorite movie segments, and a configuration file for customizing subtitles and languages.

A further embodiment of the invention provides a DVD player capable of identifying a DVD. The DVD player comprises a DVD reader for reading file information from a DVD, an identification processor for verifying whether the DVD is logged in a usage history and a database for storing at least a characteristic value and a disc profile corresponding to the DVD.

### BRIEF DESCRIPTION OF THE DRAWINGS

The following detailed description, given byway of example and not intended to limit the invention solely to the embodiments described herein, will best be understood in conjunction with the accompanying drawings, in which:

FIG. 1 is a block diagram of a disc identification system according to an embodiment of the invention;

FIG. 2a and FIG. 2b is a flowchart of disc identification according to an embodiment of the invention; and

FIG. 3 is a flowchart of disc characteristic generation.

### DETAILED DESCRIPTION OF THE INVENTION

A detailed description of an embodiment of the invention is provided in the following.

File contents vary from disc to disc, on this basis, individual characteristics may be generated accordingly to implement a disc identification mechanism. For example, a unique number can be generated by evaluating information of file contents, file name and file size of the first ten files in a disc, thus individual discs can be distinguished thereby. In addition, a database comprising tables associating the unique number with information about the disc can be established. When a disc is inserted, conventional disc identification takes place, which often fails, and a more robust identification and management system is activated to ensure the identification succeeds and further functionality is enabled.

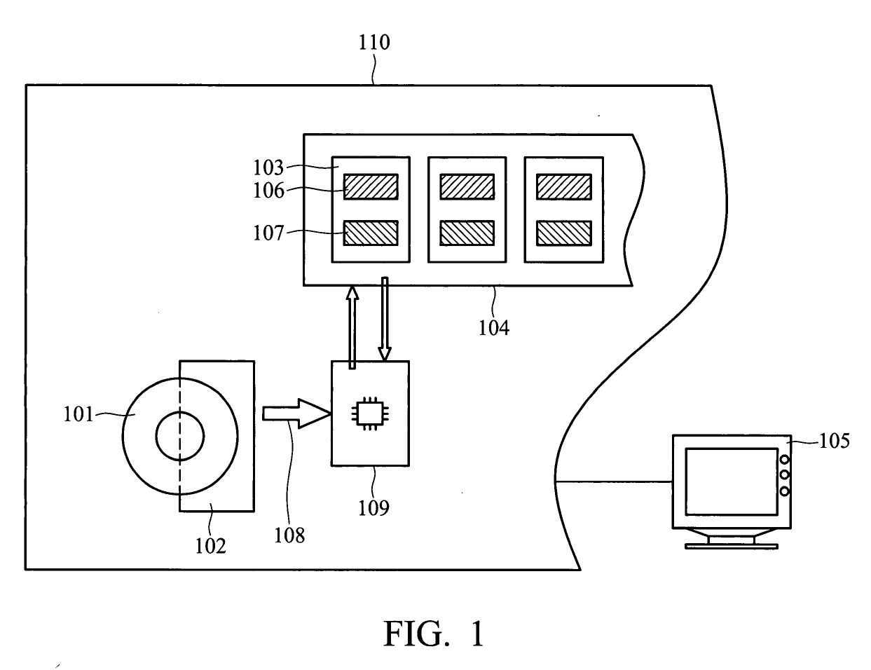

FIG. 1 shows an embodiment of the invention. A DVD player 110 with a disc identification and management system comprises a disc reader 102, an identification engine 109 and a database 104. The disc reader 102 reads disc information 108 from DVD 101, and the identification engine 109 determines if the DVD 101 has ever been played in the DVD player 110 by checking related information in the database 104. The database 104 comprises corresponding information of DVD 101 such as playback parameters and last stopping point.

After the characteristic value 106 is generated, the database 104 determines whether associated records of characteristic value 106 exist, indicating that the DVD 101 has previously been played in the DVD player 110. If the record exists, a corresponding disc profile 107 can be obtained from database 104, and further functionality can be enabled. Otherwise, if the DVD 101 is new to the DVD player 110, a new data slot 103 is created in the database 104, and corresponding new information of characteristic value 106 and disc profile 107 are generated and stored thereto. When the identification engine 109 receives an eject command, the DVD 101 is ejected, and the characteristic value 106 and disc profile 107 are kept in the corresponding data slot 103 of database 104.

In an embodiment of the invention, the database 104 comprises a plurality of data slot 103, each comprising a data pair, characteristic value 106 and disc profile 107. The characteristic value 106 is taken as a unique index of each disc, and the disc profile 107 comprises additional information for enhanced functionality, such as last stop point, file comments, favorite sections, preferred language settings and the like. The capacity of database 104 determines number of data slot 103, and the database 104 can be a storage device, or memory with a processor.

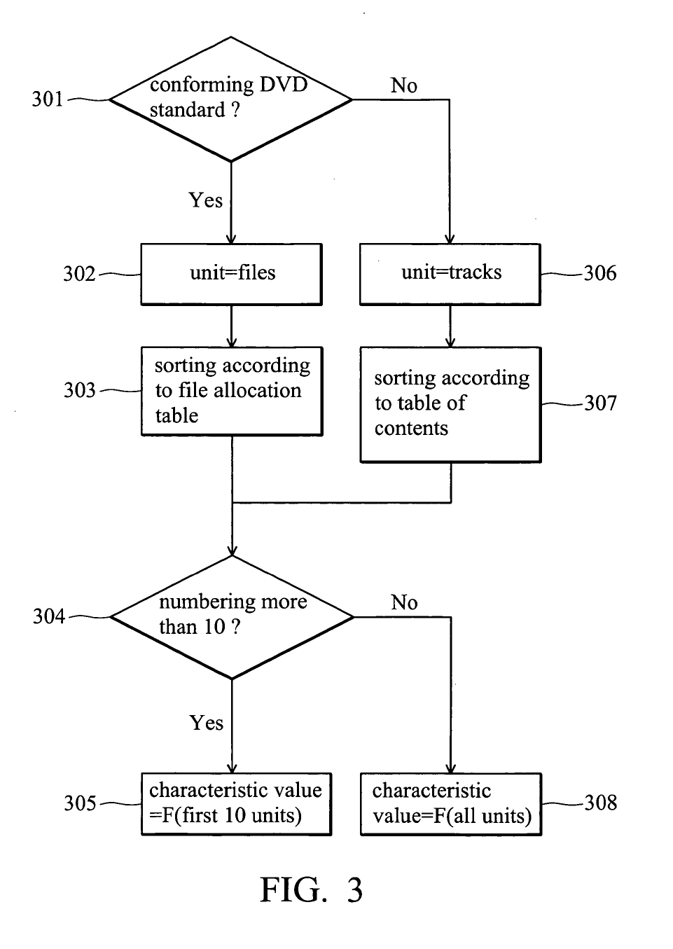

The sequence of disc identification is shown in FIG. 3. First, in step 301, assessing the DVD 101, and if the DVD 101 is assessed as conforming to the DVD standard, step 302 and step 303 are processed where information of file contents, file address and file size from a plurality of files are taken as the evaluation basis. If the DVD 101 is assessed incompatible with the DVD standard, step 306 and step 307 are processed where track content and table of contents (TOC) information are taken as the evaluation basis. Thus, disc information 108 of the DVD 101 in FIG. 1 can be obtained to generate characteristic value 106. Characteristic value 106 is a bit sequence of a certain length, long enough to distinguish discs with low collision probability. Collision is defined as presentation failure due to two different discs producing the same characteristic value 106. The generation of characteristic value 106 can be based on a hash algorithm which creates a one-to-one mapping table converting a series of given characteristics to a unique number. Step 304 determines whether more than ten files or tracks are present. If so, step 305 proceeds to generate characteristic value 106 by calculating the first ten files or tracks. If not, step 308 generates characteristic value 106 by calculating the all files or tracks.

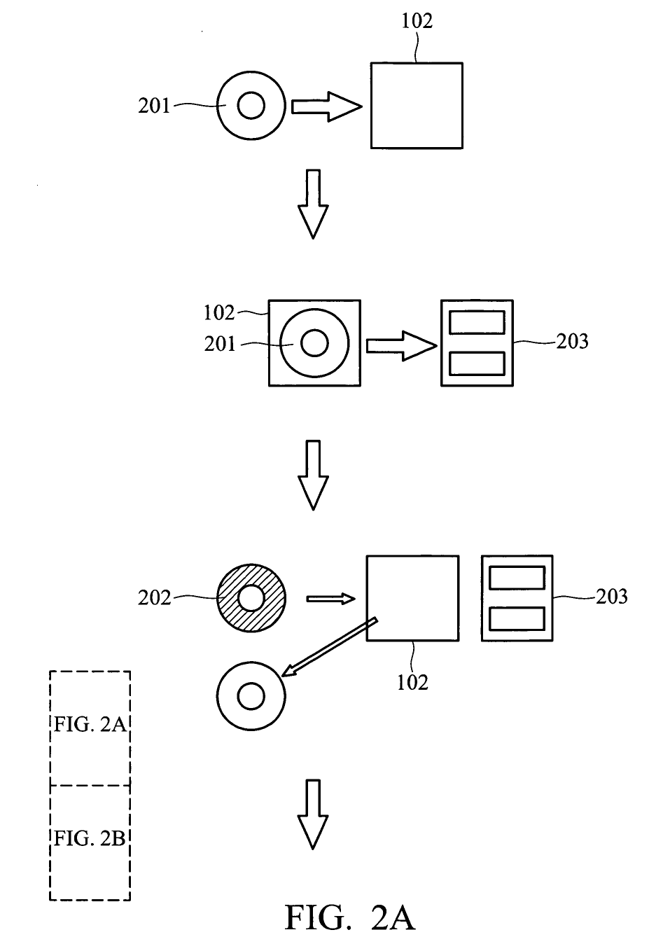

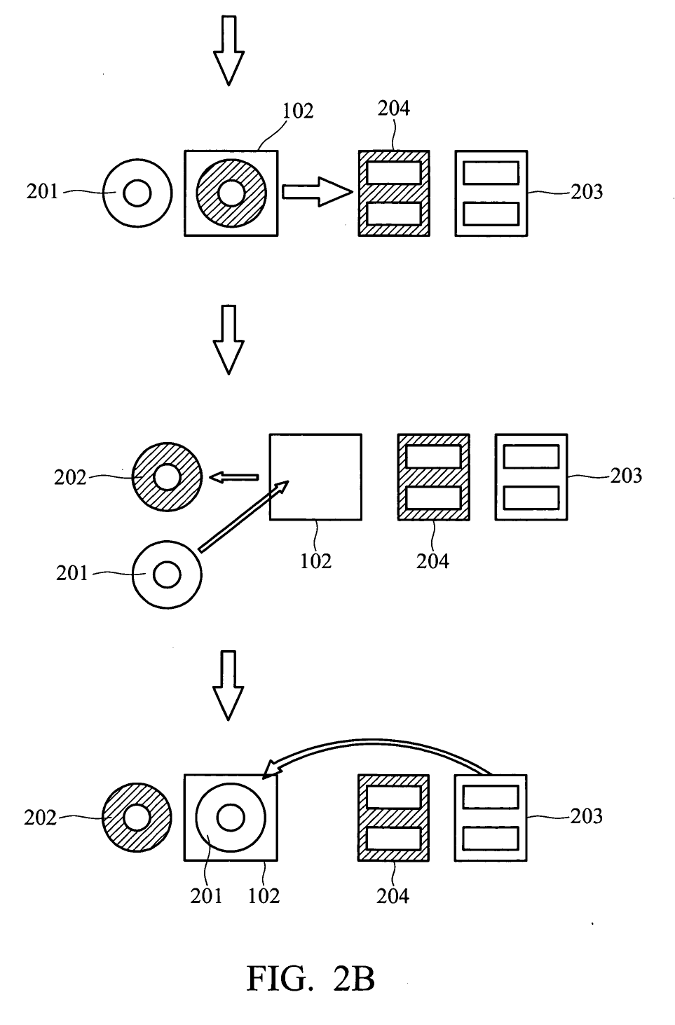

FIG. 2a and FIG. 2b show an embodiment of detailed use of the disc identification system. First, a first DVD 201 is inserted in the disc reader 102 for the first time, through assessment by identification engine 109, a first data slot 203 comprising a characteristic value 106 and a disc profile 107 is created to store related information of first DVD 201. Thereafter, the first DVD 201 is ejected and a second DVD 202 is inserted. The identification engine 109 then compares the characteristic value 106 of the second DVD 202 against all characteristic value 106 stored in the database 104. If no matching records are found, a second data slot 204 comprising a characteristic value 106 and a disc profile 107 is created to keep related information of the second DVD 202. When first DVD 201 is replaced, the identification engine 109 generates a characteristic value 106 of the first DVD 201, and through comparison against all characteristic values 106 in the database 104, a match is found in corresponding first data slot 203, thus, disc profile 107 stored therein is restored for playback.

The above described embodiments of the invention provide a flexible disc identification system preventing disc compatibility problems, and the additional database expand functionality to enhance convenience.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An identification method for a DVD player, comprising:
reading file information from a digital versatile disc (DVD);
generating a characteristic value from the file information;
verifying whether the characteristic value exists in a database; and
obtaining a corresponding disc profile for enabling further functionality if the characteristic value exists in the database.

2. The identification method as claimed in claim 1 further comprises adding the characteristic value into the database if the characteristic value does not exist in the database.

3. The identification method as claimed in claim 1 further comprises adding the corresponding disc profile into the database if the characteristic value does not exist in the database.

4. The identification method as claimed in claim 1 further comprises updating the corresponding disc profile in the database when ejecting the DVD.

5. The identification method as claimed in claim 1, wherein the generating step comprises:
determining the media type of the DVD; and
generating the characteristic value based on information comprising the file content, file address, file size, data track content and table of contents (TOC) according to the determined media type.

6. The identification method as claimed in claim 1, wherein the disc profile comprises:
a stop point for indicating the address where play last stopped;
a text column for adding descriptions of files on the DVD;
an address book for storing links to favorite movie segments; and
a configuration file for customizing subtitles and languages.

7. A database storing DVD identification information for use in a DVD player, comprising:
a characteristic column for storing a characteristic value as a primary index; and
a data column for storing a disc profile comprising customized information of a DVD.

8. The database as claimed in claim 7, wherein the disc profile comprises:
a stop point indicating the address where play last stopped;
a text column for adding descriptions of files in the DVD;
an address book for storing links to favorite movie segments; and
a configuration file for customizing subtitles and languages.

9. A DVD player capable of identifying a DVD, comprising:
a DVD reader for reading file information from a DVD;
an identification processor for verifying whether the DVD has a usage history; and
a database for storing at least a characteristic value and a disc profile corresponding to the DVD.

10. The DVD player as claimed in claim 9, wherein:
the identification processor generates the characteristic value from the file information;
the identification processor verifies whether the characteristic value exists in the database; and
the identification processor obtains the corresponding disc profile for further functionality if the characteristic value exists in the database.

11. The DVD player as claimed in claim 9, wherein the identification processor writes the characteristic value into the database if the characteristic value do not exist in the database.

12. The DVD player as claimed in claim 9, wherein the identification processor further writes the disc profile into the database if the characteristic value do not exist in the database.

13. The DVD player as claimed in claim 9, wherein the disc profile comprises:
a stop point for indicating addresses where play last stopped;
a text column for adding descriptions of files on the DVD;
an address book for storing links to favorite movie segments; and
a configuration file for customizing subtitles and languages.

14. The DVD player as claimed in claim 9, wherein when the DVD player ejects the DVD, the identification processor updates the disc profile in the database.
